(19) United States
(12) Patent Application Publication
(10) Pub. No.: US 2024/0151345 A1
(43) Pub. Date: May 9, 2024

(54) SELF-LOCATING, THERMAL, FLAME PROTECTION SLEEVE AND ASSOCIATED METHODS

(71) Applicant: FEDERAL-MOGUL POWERTRAIN LLC, Northville, MI (US)

(72) Inventors: Steven M. Galamba, West Chester, PA (US); William T. Rubel, JR., Spring Lake, NJ (US); Cassie Marie Malloy, Trappe, PA (US)

(21) Appl. No.: 18/386,453

(22) Filed: Nov. 2, 2023

Related U.S. Application Data
(60) Provisional application No. 63/422,078, filed on Nov. 3, 2022.

(51) Int. Cl. F16L 59/02; B29D 23/00

(52) U.S. Cl. CPC F16L 59/021; B29D 23/001; B29K 2105/0809

(57) ABSTRACT

A thermal, flame protective sleeve for protecting a member therein and method of construction thereof. The sleeve includes a tubular member having a circumferentially continuous wall with a straight cylindrical inner surface bounding an inner cavity extending along a central longitudinal axis between open opposite ends. At least one end cap is fixed to at least one of the opposite ends. The at least one end cap has at least one resilient tine extending radially inwardly from an outer surface of the end cap sufficiently for engagement with an elongate member extending into the inner cavity of the tubular member. The at least one end cap is silicone.

### CROSS-REFERENCE TO RELATED APPLICATION

This application claims the benefit of U.S. Provisional Application Ser. No. 63/422,078, filed Nov. 3, 2022, which is incorporated herein by reference in its entirety.

### BACKGROUND OF THE INVENTION

### 1. Technical Field

This invention relates generally to tubular sleeve assemblies that provide thermal and flame protection to a member contained therein, and more particularly to a tubular sleeve assembly including at least one self-locating member to maintain the tubular sleeve assembly in a selectively releasable, fixed position about a member contained and protected therein.

### 2. Related Art

Electric vehicle battery pack components and components located near the battery pack, such as electrical members and fluid conduits, require a high degree of thermal & flame protection if located in or near the battery pack. This is due to the possibility of the battery pack, such as lithium-ion batteries, entering into a thermal runaway condition, which can generate flame, if not suppressed, and hot gas in excess of 800° C.

What is desired is an economical, flexible, easy to assemble heat shielding tubular sleeve that will withstand the above conditions thermal and flame conditions.

### SUMMARY OF THE INVENTION

In accordance with one aspect of the invention, a thermal, flame protective sleeve for protecting a member therein against exposure to heat and flame is provided. The thermal sleeve has a tubular member including a circumferentially continuous wall with an inner surface bounding an inner cavity extending along a central longitudinal axis between open opposite ends. The at least one end cap is attached to at least one of the opposite ends. The end cap has at least one resilient tine extending radially inwardly from an outer surface of the end cap for engagement with an elongate member extending into the inner cavity of the tubular member. The end cap is silicone.

In accordance with another aspect of the invention, the at least one end cap includes a pair of end caps, with a separate one of the end caps being attached to a separate one of the opposite ends of the tubular member.

In accordance with another aspect of the invention, the circumferentially continuous wall has an outer surface, and further including an outermost coating of silicone bonded to the entirety of the outer surface.

In accordance with another aspect of the invention, the circumferentially continuous wall is a textile wall.

In accordance with another aspect of the invention, the textile wall is woven, knit or braided.

In accordance with another aspect of the invention, the circumferentially continuous wall is a non-textile, flexible wall.

In accordance with another aspect of the invention, the non-textile, flexible wall is formed of a flexible resinous material such that the wall can be freely bent and routed along arcuate paths.

In accordance with another aspect of the invention, the non-textile, flexible wall is formed silicone as a single, monolithic molded piece of material with the at least one end cap.

In accordance with another aspect of the invention, a method of constructing a sleeve for protecting a member contained in an inner cavity of the sleeve is provided. The method includes forming a tubular member having a circumferentially continuous wall with an inner surface bounding the inner cavity extending along a central longitudinal axis between opposite ends. Further, attaching at least one end cap constructed of silicone to at least one of the opposite ends.

In accordance with another aspect of the invention, the method can include attaching a separate silicone end cap to each of the opposite ends.

In accordance with another aspect of the invention, the method can include forming the circumferentially continuous wall having an outer surface and bonding a silicone coating to the outer surface.

In accordance with another aspect of the invention, the method can include molding the at least one end cap in bonded attachment to the circumferentially continuous wall.

In accordance with another aspect of the invention, the method can include molding the at least one end cap and the circumferentially continuous wall as a monolithic piece of material.

In accordance with another aspect of the invention, the method can include forming the circumferentially continuous wall as a textile wall.

In accordance with another aspect of the invention, the method can include forming the textile wall with monofilaments and/or multifilaments woven, braided or knit with one another.

In accordance with another aspect of the invention, the method can include molding the at least one end cap including a pair of end caps, with a separate end cap molded to each of the opposite ends.

In accordance with another aspect of the invention, the method can include molding the circumferentially continuous wall and the at least one end cap of silicone.

In accordance with another aspect of the invention, the method can include molding the circumferentially continuous wall and the pair of end caps located at the opposite ends of the circumferentially continuous wall of silicone.

### BRIEF DESCRIPTION OF THE DRAWINGS

These and other features and advantages of the present invention will become more readily appreciated when considered in connection with the following detailed description of presently preferred embodiments and best mode, appended claims and accompanying drawings, in which:

FIG. 1 is a schematic side view of a thermal sleeve constructed in accordance with one aspect of the invention for protecting a member therein;

FIG. 1A is a view similar to FIG. 1 showing a thermal sleeve constructed in accordance with another aspect of the invention for protecting a member therein;

FIG. 2 is a perspective view of the thermal sleeve of FIG. 1 or 1A;

FIG. 2A is a schematic perspective view of the thermal sleeve of FIG. 2 shown with an end cap removed therefrom for clarity purposes only;

FIG. 3 is an end view of an end cap of a thermal sleeve constructed in accordance with one aspect of the disclosure;

FIG. 3A is a perspective view of the end cap of FIG. 3;

FIG. 4A is a schematic cross-sectional side view of a thermal sleeve constructed in accordance with one aspect of the invention for protecting a member therein; and

FIG. 4B is a view similar to FIG. 4A showing a thermal sleeve constructed in accordance with another aspect of the invention for protecting a member therein.

### DETAILED DESCRIPTION OF PREFERRED EMBODIMENTS

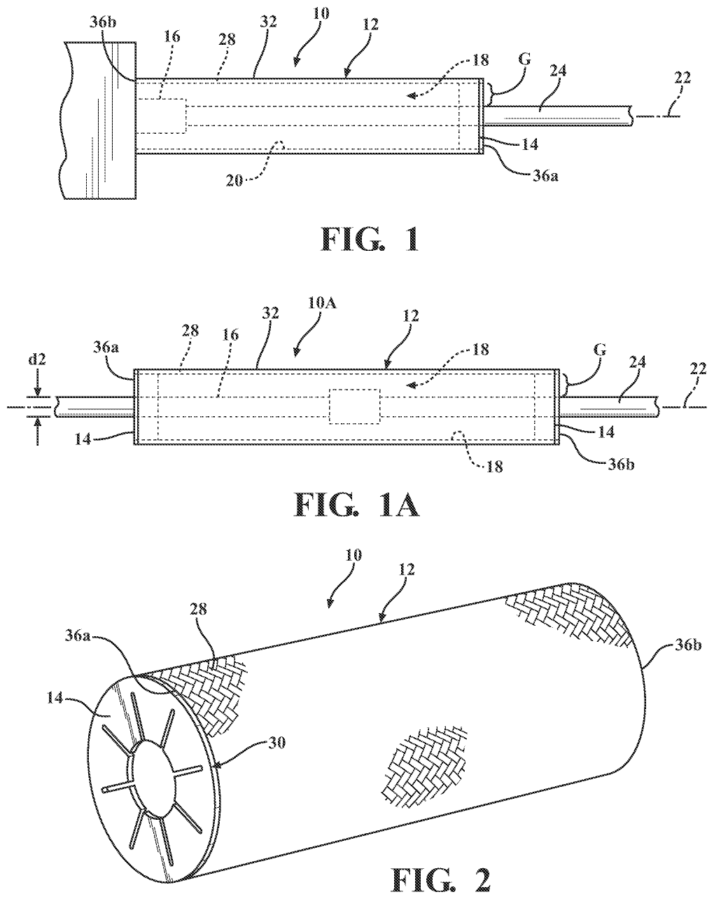

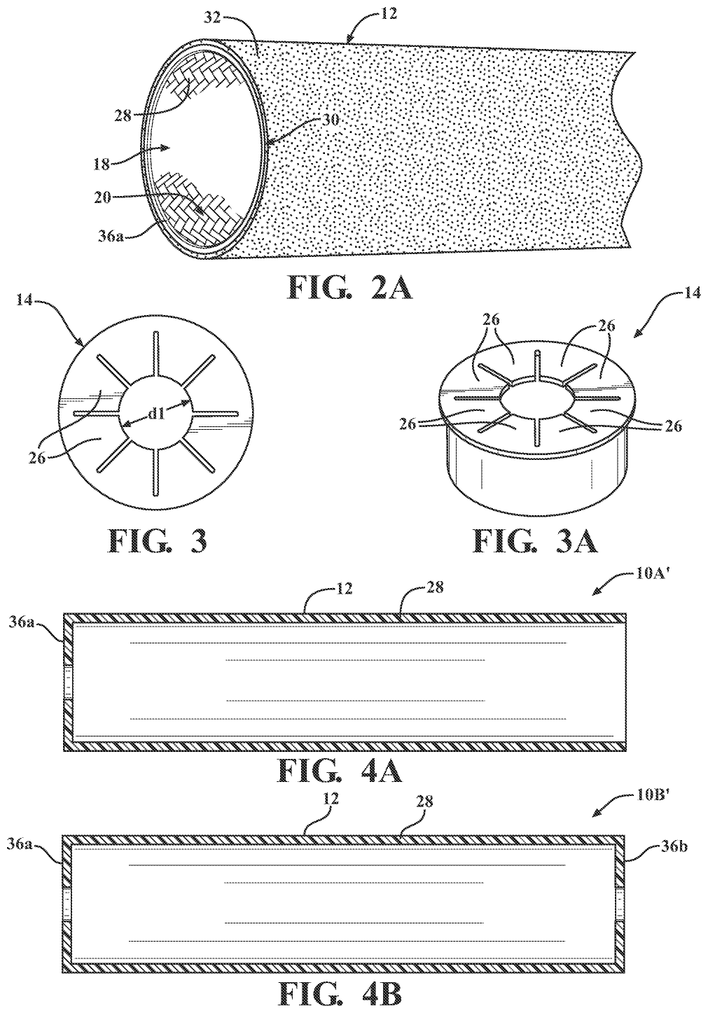

Referring in more detail to the drawings, FIGS. 1 and TA show a thermal sleeve 10, 10A, respectively, including a tubular member 12 with at least one self-retaining positioning member, referred to hereafter as end cap 14 (the thermal sleeve 10 of FIG. 1 includes one end cap 14, while the thermal sleeve 10A of FIG. 2 includes two end caps 14), constructed in accordance with one aspect of the invention, for protecting a member 16 contained at least in part in an inner cavity 18 bounded by an inner surface 20 of the tubular member 12 therein, wherein the member 16 can be an electrical sensor, fluid conduit, electrical connector, or the like, against the effects of extreme thermal heat, including radiant heat, flame, and further provides protection against contamination and vibration. The thermal sleeve 10, 10A is configured for flexing, slidable movement along a longitudinal axis 22 of an elongate member 24, such as a fluid conduit or wire harness, to bring the thermal sleeve 10, 10A into its desired protective position about the member 16. The thermal sleeve 10, 10A is highly flexible such that it can be routed over and about non-straight, arcuate bends and corners of the elongate member 24, as needed. The thermal sleeve 10, 10A, via engagement of the end cap(s) 14 with an outer surface of the elongate member 24, is configured to remain releasably fixed in the protective position until desired to selectively slide the thermal sleeve 10, 10A away from its protective position. While sliding the thermal sleeve 10, 10A axially along the longitudinal axis 22, one or a plurality of flanges, also referred to as tines 26 of the end cap(s) 14, can freely flex generally axially in opposite axial directions, as needed, to allow the thermal sleeve 10, 10A to be moved axially along the longitudinal axis 22, such as may be desired to service the member 16. The sleeve 12 remains in its protective position during use, without need of secondary fasteners, such as tape or adhesives, via frictional engagement between free ends of the tine(s) 26 and the outer surface of the elongate member 24, and thus, assembly of the thermal sleeve 10, 10A is made simple, aesthetically pleasing, while being economical in manufacture and use.

The tubular member 12 can be constructed having any desired length. The tubular member 12 includes a circumferentially continuous inner wall 28 including the inner surface 20 and an outer surface 30. The tubular member 12 further includes an outermost silicone coating 32 bonded to the entirety of the outer surface 30. The inner wall 28, in accordance with one aspect of the invention, can be constructed of a textile layer, wherein the textile layer can be woven, knit, or braided material of any desired monofilaments and/or multifilaments. In accordance with another aspect of the disclosure, the circumferentially continuous wall 28 can be constructed as a non-textile, flexible wall (can be freely routed and bent relative to the longitudinal axis 22). The non-textile, flexible wall 28 can be formed of a flexible resinous material. In accordance with another aspect, the non-textile, flexible wall 28 of a sleeve 10′, 1A′ can be formed entirely of silicone as a single, monolithic molded piece of material with the end cap(s) 14 (FIG. 4A with one end cap 14; FIG. 4B with two opposite end caps 14). The circumferentially continuous wall 28 can be constructed having any desired wall thicknesses, depending on the nature and severity of heat exposure in the intended environment, and can be provided to define an insulating air gap G extending between the member 16 and the inner surface 18 of the tubular member 12, thereby enhancing thermal protection to the member 16.

The end cap(s) 14 can be constructed of a separate piece of material from the tubular member 12 or as monolithic piece of material with the tubular member 12. The end cap(s) 14 constructed as a separate piece of material from the tubular member 12 are shown, by way of example and without limitation, as having a tubular portion 34 and at least one, and shown, by way of example and without limitation, as a plurality of the resilient flanges, also referred to as fingers or tines 26, extending radially inwardly from an outer surface of the end cap 14, such as the tubular portion 34, for abutment with the elongate member 24. Regardless of whether being formed separately or as a single piece with the tubular member 12, an inner diameter d1 extending between free ends of the tines 26 can be formed for line-to-line or slight interference fit with an outer diameter d2 of the elongate member 24. Accordingly, d1 can be equal to, or slightly less than d2, thereby providing a self-locating feature to the thermal sleeve 10, 10A, 10A′, 10B′ relative to the elongate member 24. The tubular portion 34 is shown as being sized for receipt inside one or both of the open ends 36a, 36b of the tubular member 12. It is contemplated herein that the tubular portion 34 could be sized for receipt over the outer surface 30 of the tubular member 12.

In accordance with another aspect of the invention, a method of constructing a sleeve 10, 10A, 10A′, 10B′ for protecting a member 16 contained in an inner cavity 18 of the sleeve is provided. The method includes forming a tubular member 12 having a circumferentially continuous wall 28 with an inner surface 20 bounding the inner cavity extending along a central longitudinal axis 22 between opposite ends 36a, 36b. Further, attaching at least one end cap 14 constructed of silicone to at least one of the opposite ends 36a, 36b.

In accordance with another aspect of the invention, the method can include attaching a separate silicone end cap 14 to each of the opposite ends 36a, 36b.

In accordance with another aspect of the invention, the method can include forming the circumferentially continuous wall 28 having an outer surface 30 and bonding a silicone coating 32 to the outer surface 30.

In accordance with another aspect of the invention, the method can include molding the at least one end cap 14 in bonded attachment to the circumferentially continuous wall 28.

In accordance with another aspect of the invention, the method can include molding the at least one end cap 14 and the circumferentially continuous wall 28 as a monolithic piece of material.

In accordance with another aspect of the invention, the method can include forming the circumferentially continuous wall 28 as a textile wall.

In accordance with another aspect of the invention, the method can include forming the textile wall 28 with monofilaments and/or multifilaments woven, braided or knit with one another.

In accordance with another aspect of the invention, the method can include molding the at least one end cap 14 including a pair of end caps 14, with a separate end cap 14 molded to each of the opposite ends 36a, 36b.

In accordance with another aspect of the invention, the method can include molding the circumferentially continuous wall 28 and the at least one end cap 14 entirely of silicone.

In accordance with another aspect of the invention, the method can include molding the circumferentially continuous wall 28 and the pair of end caps 14 located at the opposite ends 36a, 36b of the circumferentially continuous wall 28 of silicone.

Obviously, in light of the above teachings, many modifications and variations of the present invention are possible. It is, therefore, to be understood that within the scope of the appended claims, the invention may be practiced otherwise than as specifically described.

What is claimed is:

1. A thermal, flame protective sleeve for protecting a member therein, comprising:
a tubular member including a circumferentially continuous wall with an inner surface bounding an inner cavity extending along a central longitudinal axis between opposite ends; and
at least one end cap attached to at least one of the opposite ends, wherein the end cap has at least one resilient tine extending radially inwardly from an outer surface of the end cap for engagement with an elongate member extending into the inner cavity of the tubular member, wherein the end cap is silicone.

2. The thermal, flame protective sleeve of claim 1, wherein the at least one end cap includes a pair of end caps, with a separate one of the pair of end caps attached to a separate one of the opposite ends.

3. The thermal, flame protective sleeve of claim 2, wherein the circumferentially continuous wall has an outer surface, and further including an outermost coating of silicone bonded to the entirety of the outer surface.

4. The thermal, flame protective sleeve of claim 2, wherein the circumferentially continuous wall is a textile wall.

5. The thermal, flame protective sleeve of claim 4, wherein the textile wall is woven, knit or braided.

6. The thermal, flame protective sleeve of claim 2, wherein the circumferentially continuous wall is a non-textile, flexible wall.

7. The thermal, flame protective sleeve of claim 6, wherein the non-textile, flexible wall is formed of a flexible resinous material.

8. The thermal, flame protective sleeve of claim 1, wherein the non-textile, flexible wall is formed of silicone.

9. The thermal, flame protective sleeve of claim 8, wherein the non-textile, flexible wall is formed as a single, monolithic molded piece of material with the at least one end cap.

10. The thermal, flame protective sleeve of claim 9, wherein the at least one end cap includes a pair of end caps, with a separate one of the pair of end caps at a separate one of the opposite ends.

11. A method of constructing a sleeve for protecting a member contained in an inner cavity of the sleeve, comprising:
forming a tubular member having a circumferentially continuous wall with an inner surface bounding the inner cavity extending along a central longitudinal axis between opposite ends; and
attaching at least one end cap constructed of silicone to at least one of the opposite ends.

12. The method of claim 11, further including attaching a separate silicone end cap to each of the opposite ends.

13. The method of claim 12, further bonding a silicone coating to an outer surface of the circumferentially continuous wall.

14. The method of claim 11, further including molding the at least one end cap in bonded attachment to the circumferentially continuous wall.

15. The method of claim 14, further including molding the at least one end cap and the circumferentially continuous wall as a monolithic piece of material.

16. The method of claim 15, further including molding the at least one end cap including a pair of end caps, with a separate end cap molded to each of the opposite ends.

17. The method of claim 12, further including forming the circumferentially continuous wall as a textile wall.

18. The method of claim 17, further including forming the textile wall from monofilaments and/or multifilaments woven, braided or knit with one another.

19. The method of claim 12, further including forming the circumferentially continuous wall as a non-textile wall.

20. The method of claim 19, further including forming the circumferentially continuous wall of silicone.
